(19) United States
(12) Patent Application Publication
(10) Pub. No.: US 2014/0253158 A1
(43) Pub. Date: Sep. 11, 2014

(54) RESISTANCE MEASURING APPARATUS FOR INSPECTING COMPRESSION QUALITY AND MEASURING METHOD USING THE SAME

(71) Applicant: SUMSUNG DISPLAY CO., LTD., Yongin-City (KR)

(72) Inventors: Yoon-Duk Ko, Yongin-City (KR); Yong-Hee Lee, Yongin-City (KR)

(73) Assignee: SUMSUNG DISPLAY CO., LTD., Yongin-City (KR)

(21) Appl. No.: 13/960,744

(22) Filed: Aug. 6, 2013

(30) Foreign Application Priority Data
Mar. 7, 2013 (KR) 10-2013-0024521

(51) Int. Cl. G09G 3/00

(52) U.S. Cl. CPC G09G 3/006
USPC 324/750.16

(57) ABSTRACT

A resistance measuring apparatus for inspecting compression quality includes a probe configured to measure resistance by contacting compression resistance measuring tags of a display device, a probe support for supporting the probe, and a torque motor coupled to the probe support and configured to control a position of the probe.

### CROSS-REFERENCE TO RELATED APPLICATION

This application claims priority to and the benefit of Korean Patent Application No. 10-2013-0024521 filed in the Korean Intellectual Property Office on Mar. 7, 2013, the entire contents of which are incorporated herein by reference.

### BACKGROUND

1. Field

The described embodiments of the present invention relate to a resistance measuring apparatus for inspecting compression quality, and a measuring method using the same.

2. Description of the Related Art

In a process for a flat display device such as an organic light emitting diode (OLED) display, a liquid crystal display (LCD), and the like, a compression process is performed using an anisotropic conductive film (ACF). Such a compression process may include a film on glass (FOG) bonding process, a chip on glass (COG) bonding process, and the like.

To assure stable compression quality, a compression characteristic of a compression portion (such as alignment or indentation) is inspected through optical vision. However, such an inspection process using optical vision may increase an inferiority rate in final products, because failures cannot be digitalized, and the failure may cause progressive failure and reliability failure.

In order to reduce or minimize this failure, an electric inspection method that is capable of digitalizing the failures, and changing the failures into objective failure data may be used. Thus, resistance of the compression portion is measured using a probe, but variation may be generated in the measured resistance depending on factors such as the depth of the probe in contact with the compression portion, the degree of smoothness between a plurality of probe pins, and the like.

In addition, when a source current applied through the probe is significantly higher than a current that the compression portion can endure, the compression portion may be damaged. When the source current is significantly lower than resistance of the compression portion, resistance of the compression portion cannot be accurately measured due to noise.

The above information disclosed in this Background section is only for enhancement of understanding of the background of the described technology and therefore, it may include information that does not form the prior art that may already be known to a person of ordinary skill in the art.

### SUMMARY

The described technology provides a resistance measuring apparatus for inspecting compression quality to reduce or minimize errors in measured resistance due to measurement deviation or measurement noise, and a measurement method using the same.

A resistance measuring apparatus for inspecting compression quality according to an embodiment of the present disclosure may include a probe configured to measure resistance by contacting compression resistance measuring tags of a display device, a probe support for supporting the probe, and a torque motor coupled to the probe support and configured to control a position of the probe.

The resistance measuring apparatus may further include a displacement sensor coupled to the probe support and configured to sense displacement of the probe.

The probe may include a plurality of probe pins configured to directly contact the compression resistance measuring tags.

A vertical position of the probe pins may be controlled by the torque motor.

The resistance measuring apparatus may further include a stage configured to have the display device mounted thereon, and configured to control a vertical position of the display device.

Another embodiment of the present disclosure provides a method for measuring resistance for inspecting compression quality. The method may include sensing displacement of a probe with a displacement sensor in a probe support, controlling a position of the probe with a torque motor in the probe support according to the sensed displacement of the probe, and measuring resistance of compression portions of a display device by contacting a plurality of probe pins of the probe to compression resistance measuring tags of the display device.

The measuring the resistance may include sequentially applying a relatively smallest inspection current to a relatively largest inspection current to the compression resistance measuring tags.

The measuring the resistance may further include applying a first inspection current to the compression resistance measuring tags, and outputting a first measured resistance measured according to the first inspection current when the first measured resistance is greater than a first reference resistance.

The method may further include applying a second inspection current greater than the first inspection current to the compression resistance measuring tags when the first measured resistance is smaller than the first reference resistance, and outputting a second measured resistance measured according to the second inspection current when the second measured resistance is greater than a second reference resistance.

The method may further include applying a third inspection current greater than the second inspection current to the compression resistance measuring tags when the second measured resistance is smaller than the second reference resistance, and outputting a third measured resistance measured according to the third inspection current.

The third inspection current may be smaller than a destruction current that can destroy resistance of the compression portions.

The second reference resistance may be smaller than the first reference resistance.

According to an embodiment of the present disclosure, the resistance measuring apparatus for inspecting compression quality can control vertical pressure when probe pins contact the compression resistance measuring tags using the displacement sensor and the torque motor, and can reduce or minimize deviation in measurement by precisely controlling smoothness of the probe pins to thereby accurately measure resistance of the compression portions.

Compression quality can be quantified to objective data, and an outflow error caused due to subjective determination of a person can be avoided.

Further, not only an initial process failure, but also a potential progressive failure that cannot be detected through simple visual inspection, can be detected in advance.

When the inspection current is applied, the inspection current is variably changed depending on a resistance range of the compression portion so that an error in measured resistance due to measurement noise can be reduced or minimized, thereby measuring accurate resistance of the compression portions, and the resistance measuring apparatus for inspecting compression quality according to some embodiments of the present invention, can be applied to a display device including a compression portion having various resistance ranges.

### BRIEF DESCRIPTION OF THE DRAWINGS

FIG. 1 is a diagram of a resistance measuring apparatus for inspecting compression quality according to an embodiment of the present disclosure.

FIG. 2 is a side view of a display device where inspection is performed using the resistance measuring apparatus for inspecting compression quality according to embodiments of the present disclosure.

FIG. 3 is a top plan view of a chip on film (COF) of the display device where the inspection is performed using the resistance measuring apparatus for inspecting compression quality according to embodiments of the present disclosure.

FIG. 4 is a top plan view of a flexible printed circuit board (FPCB) of the display device where the inspection is performed using the resistance measuring apparatus for inspecting compression quality according to embodiments of the present disclosure.

FIG. 5 is a flowchart of a method for resistance measuring using the resistance measuring apparatus for inspecting compression quality according to an embodiment of the present disclosure.

### DETAILED DESCRIPTION

The embodiments of the present invention will be described more fully hereinafter with reference to the accompanying drawings, in which various embodiments of the invention are shown. As those skilled in the art would realize, the described embodiments may be modified in different ways, without departing from the spirit or scope of the various embodiments of the present invention.

The drawings and description are to be regarded as illustrative in nature and not restrictive. Like reference numerals designate like elements throughout the specification. In addition, the size and thickness of each component shown in the drawings may be arbitrarily shown for understanding and ease of description, but the embodiments of the present invention is not limited thereto.

It will be understood that when an element such as a layer, film, region, or substrate is referred to as being “on” another element, it can be directly on the other element, or one or more intervening elements may also be present.

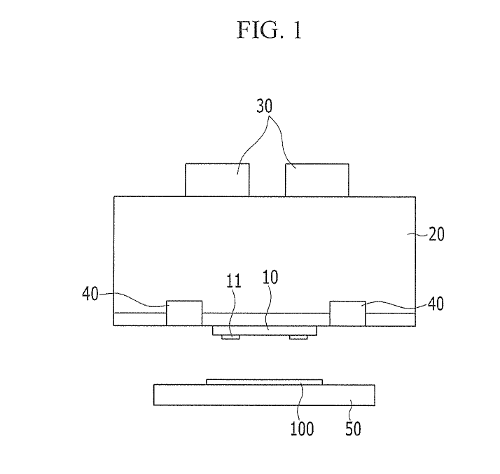

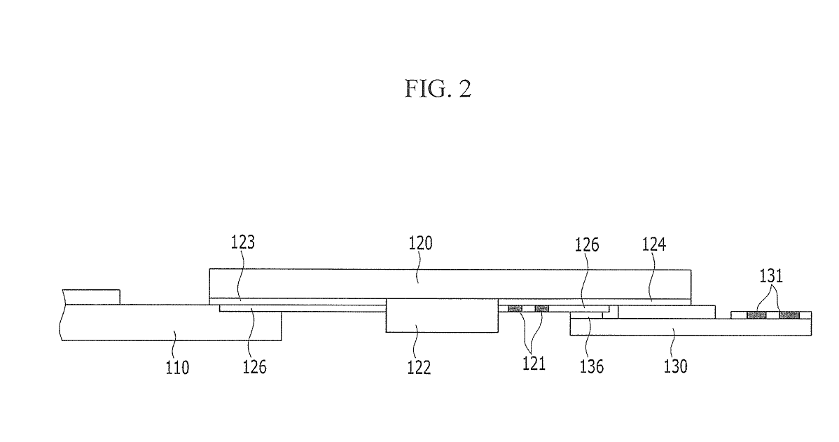

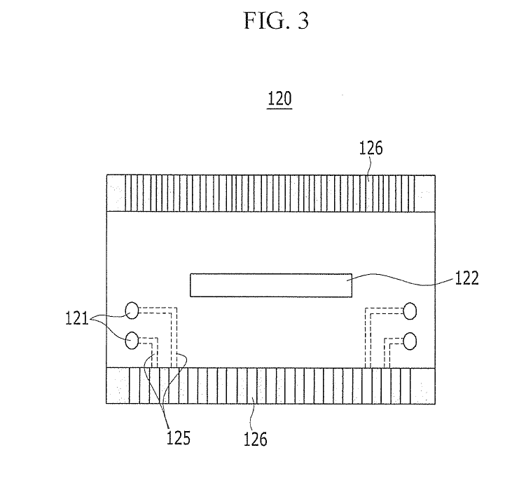

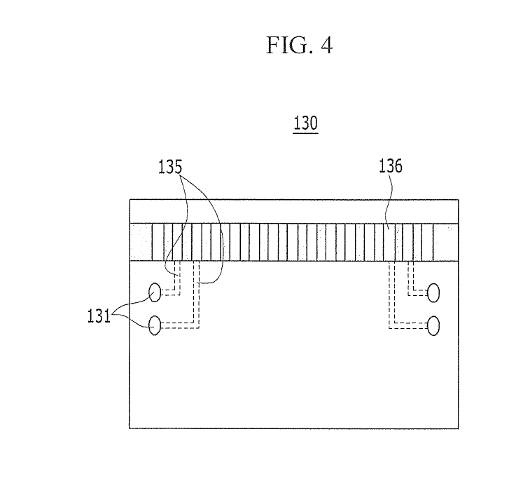

FIG. 1 is a diagram of a resistance measuring apparatus for inspecting compression quality according to an embodiment of the present disclosure. FIG. 2 is a side view of a display device where inspection is performed using the resistance measuring apparatus for inspecting compression quality according to the embodiments of the present disclosure. FIG. 3 is a top plan view of a chip on film (COF) of the display device where the inspection is performed using the resistance measuring apparatus for inspecting compression quality according to embodiments of the present disclosure. FIG. 4 is a top plan view of a flexible printed circuit board (FPCB) of the display device where the inspection is performed using the resistance measuring apparatus for inspecting compression quality according to embodiments of the present disclosure.

As shown in FIG. 1, a resistance measuring apparatus for inspecting compression quality according to an embodiment may include a probe 10 for measuring resistance of a compression portion, a probe support 20 for supporting the probe 10, a torque motor 30 attached to the probe 10 to control a position of the probe 10, a displacement sensor 40 attached to the probe support 20 to sense displacement of the probe 10, and a stage 50, to which a display device 100 is mounted, for controlling a vertical position of the display device 100.

According to an embodiment of the present invention, the probe 10 measures resistance by contacting the compression resistance measuring tags 121 and 131 (shown in FIG. 2) for measuring compression resistance of the display device 100. As shown in FIG. 2, the display device 100 is coupled with a flexible printed circuit board (FPCB) 130 using a chip on film (COF) 120 including a driving chip 122. The display device 100 is coupled with a compression portion 126 of the chip on film 120 through an anisotropic conductive film 123, and the chip on film 120 is coupled with a compression portion 136 of the flexible printed circuit board 130 through an anisotropic conductive film 124.

As shown in FIG. 3, the compression resistance measuring tag 121 is formed in the chip on film 120, according to an embodiment of the present invention. Such a compression resistance measuring tag 121 can measure resistance of the compression portion 126 because the compression resistance measuring tag 121 is coupled with a connection line(s) 125 that passes through the compression portion 126 of the chip on film 120. Although a 2-terminal compression resistance measuring tag is illustrated, according to some embodiments of the present invention, a multi-terminal (such as a 4-terminal) compression resistance measuring tag may also be applicable.

As shown in FIG. 4, the compression resistance measuring tag 131 is formed in the flexible printed circuit board 130, according to an embodiment of the present invention. Such a compression resistance measuring tag 131 can measure resistance of the compression portion 136 because the compression resistance measuring tag 131 is coupled with a connection line(s) 135 that passes through the compression portion 136 of the flexible printed circuit board 130.

In some embodiments, the probe 10 includes a plurality of probe pins 11 that are configured to respectively directly contact the compression resistance measuring tags 121 and 131. Vertical position of the probe pins 11 may be controlled by the torque motor 30.

In some embodiments, the displacement sensor 40 is provided in a lower portion of the probe support 20, and is configured to measure smoothness of the probe pins 11 that contact the compression resistance measuring tags 121 and 131.

The torque motor 30 controls a vertical position of the probe pins 11 using the smoothness of the probe pins 11 measured by the displacement sensor 40 for the probe pins 11 to uniformly contact the compression resistance measuring tags 121 and 131.

According to an embodiment of the present invention, when the vertical position of the probe pins 11 (controlled using the displacement sensor 40 and the torque motor 30) contact the compression resistance measuring tags 121 and 131, variation in measurement can be reduced or minimized by accurately controlling the smoothness of the probe pins 11.

A method for measuring the resistance using the resistance measuring apparatus for inspecting compression quality according to embodiments of the present invention will now be described in detail with reference to FIG. 1 to FIG. 5.

As shown in FIG. 1, a measurement method using the resistance measuring apparatus for inspecting compression quality, according to embodiments of the present invention, senses displacement of the probe 10 using the displacement sensor 40 provided in the probe support 20.

The position of the probe 10 is controlled, using the torque motor 30 provided in the probe support 20, with reference to sensed displacement of the probe 10.

The resistance of the compression portions 126 and 136 may be measured by contacting the plurality of probe pins 11 of the probe 10 to the compression resistance measuring tags 121 and 131.

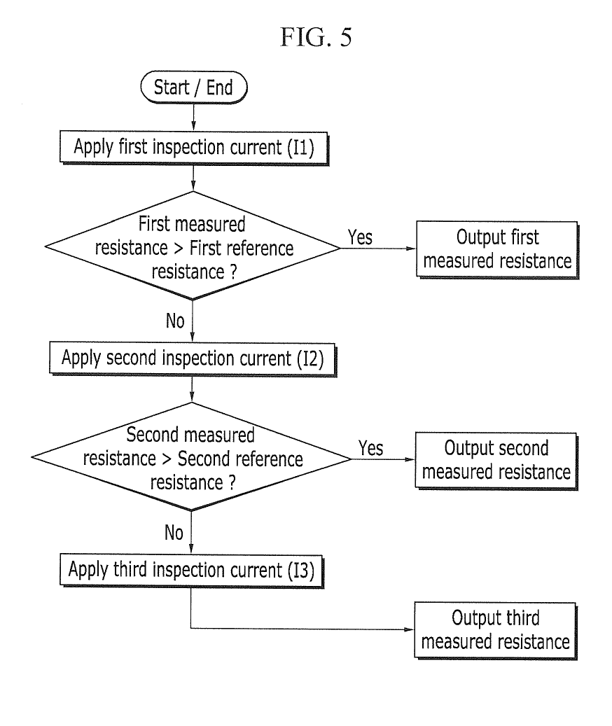

As shown in FIG. 5, a relatively smallest inspection current I1 to a relatively largest inspection current I3 are sequentially applied to the compression resistance measuring tags 121 and 131 for measuring resistance of the compression portions 126 and 136, according to embodiments of the present invention. By applying these inspection currents (I1 to I3), automatic offset can be applied to the probe 10 to reduce or eliminate resistance of the probe 10.

This will be described in further detail hereinafter with reference to FIG. 5.

According to an embodiment of the present invention, a first inspection current I1 is applied to the compression resistance measuring tags 121 and 131. When a first measured resistance measured by the first inspection current I1 is greater than a first reference resistance, the first measured resistance is outputted. When the first measured resistance is smaller than (e.g., smaller than or equal to) the first reference resistance, a second inspection current I2 that is greater than the first inspection current I1 is applied to the compression resistance measuring tags.

When a second measured resistance measured by the second inspection current I2 is greater than a second reference resistance, the second measured resistance is outputted. When the second measured resistance is smaller than (e.g., smaller than or equal to) the second reference resistance, a third inspection current that is greater than the second inspection current I2 is applied to the compression resistance measuring tags. Then, a third measured resistance measured by the third inspection current I3 is outputted.

Accordingly, in the present embodiment, the second reference resistance is smaller than the first reference resistance, and the third inspection current is smaller than a destruction current, (e.g., a current that could destroy the resistance of the compression portion).

For example, when the first inspection current I1 of 100 μA is applied, and when the first measured resistance is greater than the first reference resistance of 100Ω, the first measured resistance is outputted. When the first measured resistance is smaller than the first reference resistance of 100Ω, the second inspection current I2 of 500 μA is applied to the compression resistance measuring tags 121 and 131. Further, when the second measured resistance is greater than the second reference resistance, the second measured resistance is outputted. When the second measured resistance is smaller than the second reference resistance of 50Ω, the third inspection current I3 of 1 mA is applied to the compression resistance measuring tags 121 and 131 to output the third measured resistance.

According to some embodiments, the first inspection current I1, the second inspection current I2, and/or the third inspection current I3, each respectively having currents of different magnitudes, are applied to the compression resistance measuring tags 121 and 131, depending on a resistance range of the compression portions 126 and 136, to output the first, second, or third measured resistances. Thus, the inspection current is incrementally increased (e.g., I1, I2, and I3) to avoid destroying the compression portions 126 and 136 due to application of an inspection current that is significantly greater than an inspection current that the compression portions 126 and 136 can endure. In addition, an occurrence of measurement noise due to applying the inspection current that is significantly smaller than the resistance of the compression portions 126 and 136 can also be avoided.

That is, when an inspection current is applied to the compression portions 126 and 136, the intensity of the inspection current can be changed depending on a resistance range of the compression portions 126 and 136 to thereby measure accurate resistance of the compression portions 126 and 136.

In some embodiments of the present invention, a fixed current measuring method may be used to measure the resistance using an inspection current. The fixed current measuring method of embodiments of the present invention measures resistance by generating a slope between the lowest inspection current and the highest inspection current in a voltage vs. current curve (graph). Accordingly, time for stabilizing measurement is relatively shorter due to lesser resistance measurement points, thereby shortening the time available for measuring resistance. Further, the resistance measurement obtained according to the fixed current measuring method may be accurate because an occurrence of measurement error is reduced due to the lesser number of resistance measurement points.

In some embodiments, a very small amount of noise from the probe or the peripheral environment may be included in the measured resistance, which can be filtered through averaging the noise.

While this disclosure has been described in connection with what is presently considered to be practical example embodiments, it is to be understood that the invention is not limited to the disclosed embodiments, but, to the contrary, is intended to cover various modifications and equivalent arrangements included within the spirit and scope of the appended claims, and their equivalents.

### DESCRIPTION OF SOME OF THE REFERENCE CHARACTERS

| | |
|---|---|
| 10: probe | 20: probe support |
| 30: torque motor | 40: displacement sensor |
| 50: STAGE | |

What is claimed is:

1. A resistance measuring apparatus for inspecting compression quality, the apparatus comprising:
a probe configured to measure resistance by contacting compression resistance measuring tags of a display device;
a probe support for supporting the probe; and
a torque motor coupled to the probe support and configured to control a position of the probe.

2. The resistance measuring apparatus of claim 1, further comprising a displacement sensor coupled to the probe support and configured to sense displacement of the probe.

3. The resistance measuring apparatus of claim 2, wherein the probe comprises a plurality of probe pins configured to directly contact the compression resistance measuring tags.

4. The resistance measuring apparatus of claim 3, wherein a vertical position of the probe pins is controlled by the torque motor.

5. The resistance measuring apparatus of claim 1, further comprising a stage configured to have the display device mounted thereon, and configured to control a vertical position of the display device.

6. A method for measuring resistance for inspecting compression quality, the method comprising:
sensing displacement of a probe with a displacement sensor in a probe support;
controlling a position of the probe with a torque motor in the probe support according to the sensed displacement of the probe; and
measuring resistance of compression portions of a display device by contacting a plurality of probe pins of the probe to compression resistance measuring tags of the display device.

7. The method of claim 6, wherein the measuring the resistance comprises sequentially applying a relatively smallest inspection current to a relatively largest inspection current to the compression resistance measuring tags.

8. The method of claim 7, wherein the measuring the resistance further comprises:
applying a first inspection current to the compression resistance measuring tags; and
outputting a first measured resistance measured according to the first inspection current when the first measured resistance is greater than a first reference resistance.

9. The method of claim 8, further comprising:
applying a second inspection current greater than the first inspection current to the compression resistance measuring tags when the first measured resistance is smaller than the first reference resistance; and
outputting a second measured resistance measured according to the second inspection current when the second measured resistance is greater than a second reference resistance.

10. The method of claim 9, further comprising:
applying a third inspection current greater than the second inspection current to the compression resistance measuring tags when the second measured resistance is smaller than the second reference resistance; and
outputting a third measured resistance measured according to the third inspection current.

11. The method of claim 10, wherein the third inspection current is smaller than a destruction current that can destroy resistance of the compression portions.

12. The method of claim 10, wherein the second reference resistance is smaller than the first reference resistance.
